(19) United States
(12) Patent Application Publication
(10) Pub. No.: US 2008/0026795 A1
(43) Pub. Date: Jan. 31, 2008

(54) BASE STATION APPARATUS AND CONTROL METHOD THEREOF

(75) Inventor: Kenichi Fujii, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: Canon Kabushiki Kaisha, Tokyo (JP)

(21) Appl. No.: 11/777,416

(22) Filed: Jul. 13, 2007

(30) Foreign Application Priority Data
Jul. 27, 2006 (JP) 2006-205315

(51) Int. Cl. H04B 1/38

(52) U.S. Cl. 455/561

(57) ABSTRACT

A base station apparatus notifies an operable method of a plurality of wireless parameter setting methods of a wireless terminal, and the operable method is switched depending on the operation state of each of the wireless parameter setting methods. Any of the wireless parameter setting methods is selected based on a request for a wireless parameter setting method from the wireless terminal and the operation state of each of the wireless parameter setting methods. Parameter setting method between the base station apparatus and the wireless terminal is performed according to the selected wireless parameter setting method.

### BACKGROUND OF THE INVENTION

1. Field of the Invention

The present invention relates to a base station apparatus and a control method thereof that are capable of setting parameters by a plurality of wireless parameter setting methods.

2. Description of the Related Art

With the widespread use of wireless LANs, there is an increasing need for a wireless parameter setting technique for easy setting of parameters required for wireless LAN communication, such as an SSID (Service Set Identifier), encryption method, encryption key, authentication method, and authentication key, which are complicated for a user.

Conventionally, vendors of wireless LAN apparatuses simplify the wireless parameter setting by incorporating their proprietary wireless parameter setting techniques into their products. With respect to such wireless parameter setting techniques, Japanese Patent Laid-Open No. 2004-215232 discloses the wireless communication of the parameters required for wireless LAN communication between a wireless terminal and a base station apparatus.

In recent years, establishment of a standard for wireless parameter setting techniques has been in progress for easy setting of wireless parameters between apparatuses of different vendors. It is therefore expected that future wireless LAN apparatuses will have both a vendor's proprietary wireless parameter setting method (hereinafter referred to as a peculiar method) for their conventional apparatuses and a standard wireless parameter setting method (hereinafter referred to as a standard method) that will become popular from now on.

Each of these peculiar and standard methods sets wireless parameters between a base station apparatus and wireless terminals communicating therewith based on a different setting algorithm. When a base station apparatus with such standard and peculiar wireless parameter setting methods sets wireless parameters between the apparatus and a wireless terminal, the apparatus needs to start a wireless parameter setting method corresponding to that wireless terminal. Therefore, a plurality of buttons or the like are necessary for selecting among the setting methods in the base station apparatus. In addition, a user of the wireless terminal must know in advance the wireless parameter setting methods supported by the base station apparatus. This poses a problem of compromised operability.

### SUMMARY OF THE INVENTION

An aspect of the present invention is to solve the previously seen problems described above.

Another aspect of the present invention is to provide a technique, in the situation where a base station apparatus has a plurality of wireless parameter setting methods, for easily selecting among these wireless parameter setting methods to set wireless parameters without the need of an operation for selecting a setting method at the time of setting the wireless parameters.

According to an aspect of the present invention, there is provided a base station apparatus having a plurality of wireless parameter setting methods for setting wireless parameters between the base station apparatus and a wireless terminal, comprising:

a broadcast unit configured to notify of an operable method of the plurality of wireless parameter setting methods;

a switching unit configured to switch the operable method to be notified by the broadcast unit depending on an operation state of each of the plurality of wireless parameter setting methods;

a selection unit configured to select any of the plurality of wireless parameter setting methods based on a request for a wireless parameter setting method from a wireless terminal; and

a wireless parameter setting unit configured to perform setting processing according to the wireless parameter setting method selected by the selection unit.

According to an aspect of the present invention, there is provided a control method for a base station apparatus having a plurality of wireless parameter setting methods for setting wireless parameters between the base station apparatus and a wireless terminal, comprising:

a broadcast step of notifying of an operable method of the plurality of wireless parameter setting methods;

a switching step of switching the operable method to be notified in the broadcast step depending on an operation state of each of the plurality of wireless parameter setting methods;

a selection step of selecting any of the plurality of wireless parameter setting methods based on a request for a wireless parameter setting method from a wireless terminal and the operation state of each of the plurality of wireless parameter setting methods; and

a wireless parameter setting step of performing setting processing according to the wireless parameter setting method selected in the selection step.

Further features an and aspects of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic diagram describing a wireless communication system according to exemplary embodiments of the present invention;

FIG. 2 is a block diagram showing the configuration of a base station apparatus according to the embodiments;

FIG. 3 is a block diagram showing the configuration of a first wireless terminal according to the embodiments;

FIG. 4 is a block diagram showing the configuration of a second wireless terminal according to the embodiments;

FIG. 5 is a state transition diagram of wireless parameter setting methods controlled by a switching processor of the base station apparatus according to the embodiments; according to the embodiments;

FIG. 6 is a diagram describing the formats of a wireless broadcast signal and a response signal for a search request switched depending on the state of the setting methods by the switching processor of the base station apparatus according to a first embodiment;

FIGS. 7 and 8 depict flowcharts describing wireless parameter setting processing of the base station apparatus according to the first embodiment;

FIG. 9 is a flowchart describing processing of the wireless terminal according to the first embodiment for acquiring wireless parameters from the base station apparatus by a third wireless parameter setting method;

FIG. 10 is a diagram describing the formats of the broadcast signal and the response signal switched depending on the state of the setting methods by the switching processor of the base station apparatus according to a second embodiment;

FIGS. 11A and 11B are flowcharts describing a wireless parameter setting process of the base station apparatus according to the second embodiment of the present invention;

FIG. 12 is a diagram describing the formats of the broadcast signal and the search response signal switched depending on the state of the setting methods by the switching processor of the base station apparatus according to a third embodiment of the present invention;

FIG. 13 is a flowchart describing a wireless parameter setting process of the base station apparatus according to the third embodiment;

FIG. 14 is a diagram describing the formats of the broadcast signal and the search response signal switched depending on the state of the setting methods by the switching processor of the base station apparatus according to a fourth embodiment; and

FIGS. 15A and 15B are flowcharts describing a wireless parameter setting process of the base station apparatus according to the fourth embodiment.

### DESCRIPTION OF THE EMBODIMENTS

Numerous embodiments of the present invention will now herein be described in detail below with reference to the accompanying drawings. It should be noted that the following embodiments are not intended to limit the present invention set forth in the claims and that not all of the combinations of features described in the embodiments are necessarily essential as means for solving the present invention.

### First Embodiment

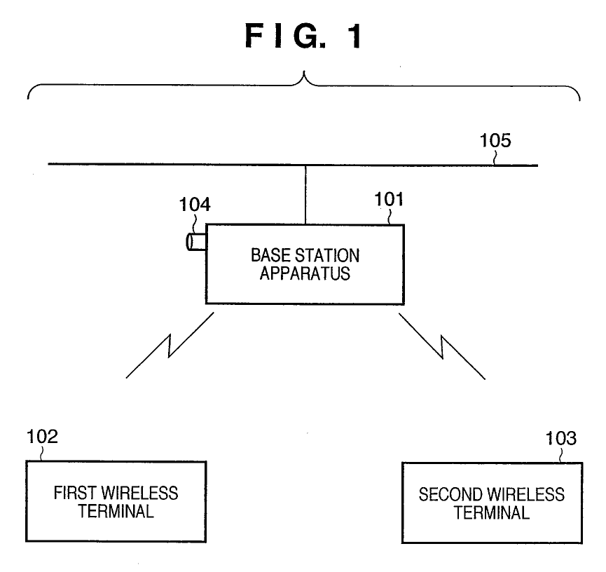

FIG. 1 is a schematic diagram describing a wireless communication system according to the embodiments of the present invention.

The wireless communication system includes a base station apparatus 101, a first wireless terminal 102, and a second wireless terminal 103. A setting button 104 is a console unit of the base station apparatus 101. The base station apparatus 101, the first wireless terminal 102, and the second wireless terminal 103 has an IEEE802.11 wireless LAN communication function, so that they wirelessly communicate by wireless LAN infrastructure (hereinafter referred to as “infra”) communication. The base station apparatus 101 is connected to a wired LAN 105.

It is to be understood that the number of wireless terminals is not limited to that shown in FIG. 1 but more wireless terminals may be included.

It is assumed here that the first wireless terminal 102 adopts a second wireless parameter setting method, whereas the second wireless terminal 103 adopts a third wireless parameter setting method. The base station apparatus 101 can set parameters by any of a first, the second, and the third wireless parameter setting methods.

The first wireless parameter setting method is a method by which a wireless terminal receives wireless parameters from the base station apparatus 101 and sets the wireless parameters without operation on the base station apparatus 101. This method requires operation on the wireless terminal, such as entering an ID for authentication between the base station apparatus 101 and the wireless terminal. Once the authentication between the base station apparatus 101 and the wireless terminal is completed, wireless parameters are transmitted from the base station apparatus 101 to the wireless terminal according to a protocol of the first wireless parameter setting method. Both the second and third wireless parameter setting methods are methods by which a wireless terminal receives wireless parameters from the base station apparatus 101 and sets the wireless parameters when the setting button 104 of the base station apparatus 101 and a setting button (not shown) of the wireless terminal are operated within a predetermined time period. In the second wireless parameter setting method, “ESSID for setting method 2” is set as a network identifier of the base station apparatus 101 when its setting button 104 is operated. The network identifier “ESSID for setting method 2” is also set in the wireless terminal when its setting button is operated, so that a network for setting wireless parameters is temporarily formed between the wireless terminal and the base station apparatus 101. Over the formed network, wireless parameters are transmitted from the base station apparatus 101 to the wireless terminal according to a protocol of the second wireless parameter setting method. In the third wireless parameter setting method, a broadcast signal (beacon) or a response signal for a search signal is transmitted when the setting button 104 is operated, with additional information indicating the third wireless parameter setting method included in the signal. In response to a setting request from the wireless terminal having received the broadcast signal or the response signal, wireless parameters are transmitted from the base station apparatus 101 to the wireless terminal according to a protocol of the third wireless parameter setting method.

The wireless terminals 102 and 103 having received the wireless parameters by any of the above wireless parameter setting methods can communicate with apparatuses connected to the wired LAN 105 via the base station apparatus 101.

The following embodiments will be described about operation of the base station apparatus 101 in the case where the third wireless parameter setting method is to be implemented between the base station apparatus 101 and the wireless terminal 103 while the first, second, and third wireless parameter setting methods are operating in the base station apparatus 101.

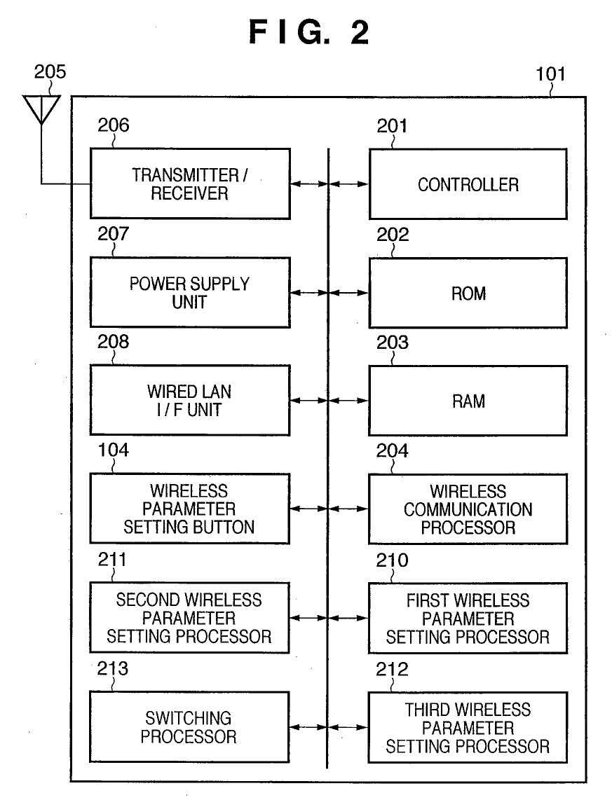

FIG. 2 is a block diagram showing the configuration of the base station apparatus 101 according to the embodiments.

In FIG. 2, a controller 201 controls operation of the entire base station apparatus 101. A ROM 202 stores control commands, i.e., programs and various kinds of data, to be executed by a CPU (not shown) of the controller 201. A RAM 203 provides a work area for storing various kinds of data during control processing of the controller 201 and also stores a table for storing wireless parameters. A wireless communication processor 204 controls communication according to wireless LAN 802.11. Reference numeral 205 denotes an antenna. A transmitter/receiver 206 controls transmission and reception of signals via the antenna 205. A power supply unit 207 supplies electric power to components of the base station apparatus 101. A wired LAN interface unit 208 controls interfacing with the wired LAN 105.

The wireless parameter setting button 104 is a button operated by a user to start wireless parameter setting processing. A first wireless parameter setting processor 210 controls processing of setting first wireless parameters. A second wireless parameter setting processor 211 controls processing of setting second wireless parameters. A third wireless parameter setting processor 212 controls processing of setting third wireless parameters. A switching processor 213 controls switching of the wireless broadcast signal and the response signal for a search request depending on a currently enabled wireless parameter setting method.

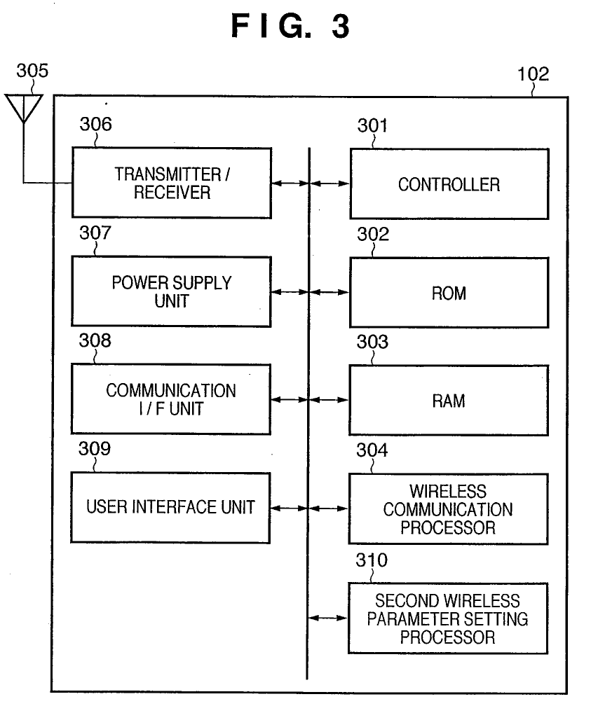

FIG. 3 is a block diagram showing the configuration of the first wireless terminal 102 according to the embodiments.

In FIG. 3, a controller 301 controls operation of the entire first wireless terminal 102. A ROM 302 stores control commands, i.e., programs and various kinds of data, to be executed by a CPU (not shown) of the controller 301. A RAM 303 provides a work area for storing various kinds of data during control processing of the controller 301. A wireless communication processor 304 controls communication according to wireless LAN 802.11. Reference numeral 305 denotes an antenna. A transmitter/receiver 306 controls transmission and reception of data via the antenna 305. A power supply unit 307 supplies electric power to components of the first wireless terminal 102. A communication interface (I/F) unit 308 is an interface for communication other than wireless communication, such as USB or IEEE 1394, for example. Reference numeral 309 denotes a user interface (UI) unit. A second wireless parameter setting processor 310 controls processing of setting the second wireless parameters.

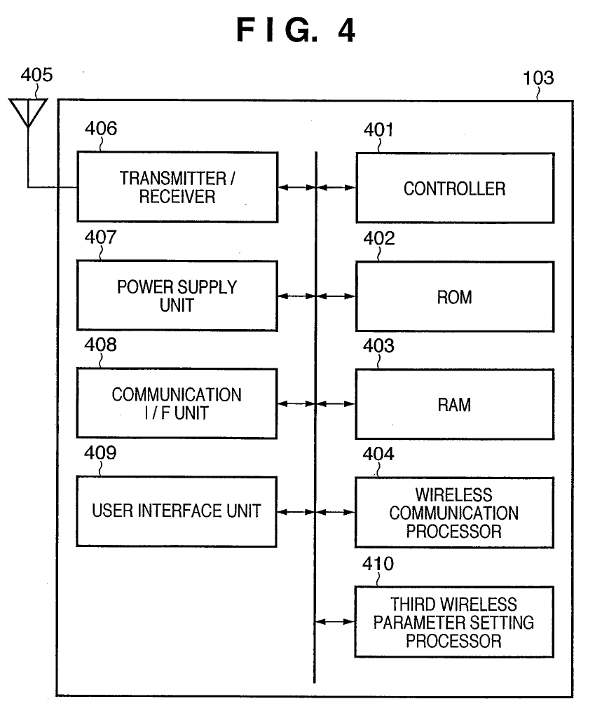

FIG. 4 is a block diagram showing the configuration of the second wireless terminal 103 according to the embodiments.

In FIG. 4, a controller 401 controls operation of the entire second wireless terminal 103. A ROM 402 stores control commands, i.e., programs and various kinds of data, to be executed by a CPU (not shown) of the controller 401. A RAM 403 provides a work area for storing various kinds of data during control processing of the controller 401. A wireless communication processor 404 controls communication according to wireless LAN 802.11. Reference numeral 405 denotes an antenna. A transmitter/receiver 406 controls transmission and reception of data via the antenna 405. A power supply unit 407 supplies electric power to components of the second wireless terminal 103. A communication interface (I/F) unit 408 is an interface for communication other than wireless communication, such as USB or IEEE 1394, for example. Reference numeral 409 denotes a user interface (UI) unit. A third wireless parameter setting processor 410 controls processing of setting the third wireless parameters.

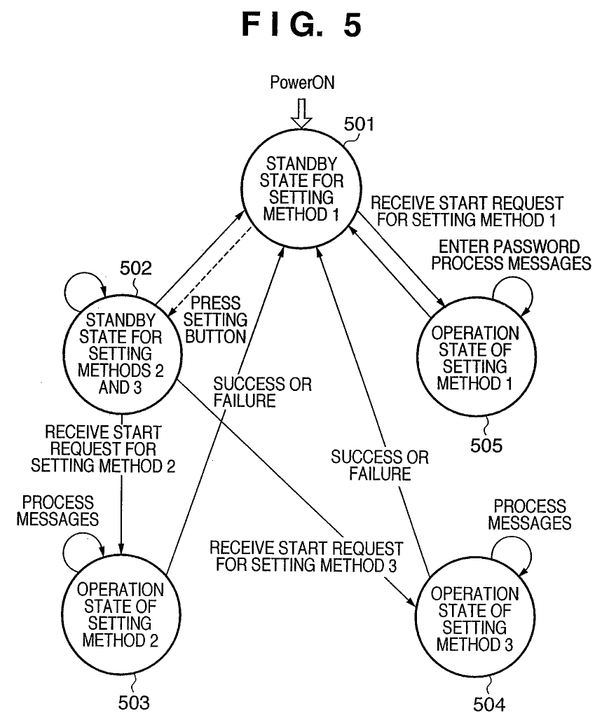

FIG. 5 is a state transition diagram of the wireless parameter setting methods controlled by the switching processor 213 of the base station apparatus 101 according to the embodiments.

Upon power-on of the base station apparatus 101, the controller 201 controls the first wireless parameter setting processor 210 to request the switching processor 213 to switch the broadcast signal and the response signal for a search request. This brings the apparatus into a “standby state for setting method 1” 501 in which the first wireless parameter setting method can be started. In this state 501, when the wireless parameter setting button 104 is pressed, the controller 201 controls the second wireless parameter setting processor 211 and the third wireless parameter setting processor 212 to request the switching processor 213 to switch the broadcast signal and the response signal. This brings the apparatus into a “standby state for setting methods 2 and 3” 502 in which both the second and third wireless parameter setting methods can be started.

In this state 502, when the base station apparatus 101 receives from a wireless terminal a “start request for setting method 2” for activating the second wireless parameter setting method, the apparatus transitions to an “operation state of setting method 2” 503 to perform message processing required for setting wireless parameters. Also in the state 502, when the base station apparatus 101 receives a “start request for setting method 3” for activating the third wireless parameter setting method, the apparatus transitions to an “operation state of setting method 3” 504 to perform message processing required for setting wireless parameters. Upon completion of the processing in these states 503 and 504, the apparatus returns to the initial “standby state for setting method 1” 501 in which the first wireless parameter setting method can be activated.

In the “standby state for setting method 1” 501, when the base station apparatus 101 receives from a wireless terminal a “start request for setting method 1” for activating the first wireless parameter setting method, the apparatus transitions to an “operation state of setting method 1” 505. This state 505 requires entry of a password and processing of message in order to set wireless parameters. In this state, the wireless terminal receives wireless parameters from the base station apparatus 101 and sets the wireless parameters into the wireless terminal.

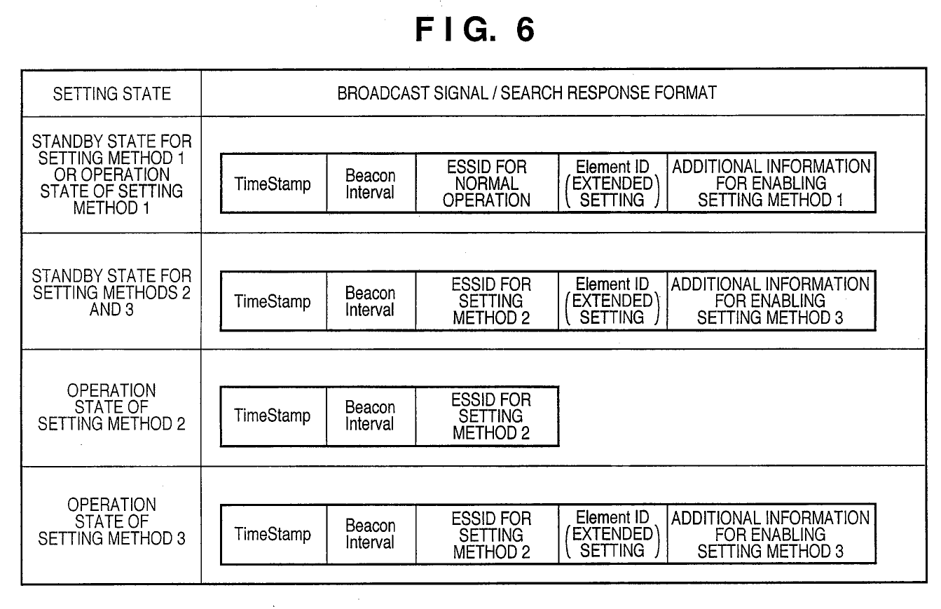

FIG. 6 is a diagram describing the formats of the wireless broadcast signal and the response signal for a search request switched depending on the state of the setting methods by the switching processor 213 of the base station apparatus 101 according to an embodiment.

In a case that the base station apparatus 101 is in the “standby state for setting method 1” 501 or the “operation state of setting method 1” 505, the broadcast/search response signal format includes TimeStamp indicating a timestamp, and BeaconInterval indicating the transmission time interval of the broadcast signal. Further, “ESSID for normal operation” indicating the same value as an identifier in normal operation is set as the network identifier. Also set are ElementID (extended setting) indicating the presence of additional information representing the first wireless parameter setting method, and “additional information for enabling setting method 1”.

In a case that the base station apparatus 101 is set to the “standby state for setting methods 2 and 3” 502, the broadcast/search response signal format includes the TimeStamp indicating a timestamp, and the BeaconInterval indicating the transmission time interval of the broadcast signal. Also, “ESSID for setting method 2”, which is an identifier indicating that the second wireless parameter setting method is operating, is set as the network identifier. Further set are ElementID (extended setting) indicating the presence of additional information representing the third wireless parameter setting method, and “additional information for enabling setting method 3”.

In a case that the base station apparatus 101 is set to the “operation state of setting method 2” 503, the broadcast/search response signal format includes the TimeStamp indicating a timestamp, and the BeaconInterval indicating the transmission time interval of the broadcast signal. Also, the “ESSID for setting method 2”, which is an identifier indicating that the second wireless parameter setting method is operating, is set as the network identifier. The additional information representing the third wireless parameter setting method is deleted here.

In a case that the base station apparatus 101 is set to the “operation state of setting method 3” 504, the broadcast/search response signal format includes the TimeStamp indicating a timestamp, and the BeaconInterval indicating the transmission time interval of the broadcast signal. Since the wireless network is already configured, the “ESSID for setting method 2”, which is an identifier indicating that the second wireless parameter setting method is operating, is still set as the network identifier in order to prevent disconnection. Further set are the ElementID (extended setting) indicating the presence of additional information representing the third wireless parameter setting method, and the “additional information for enabling setting method 3”.

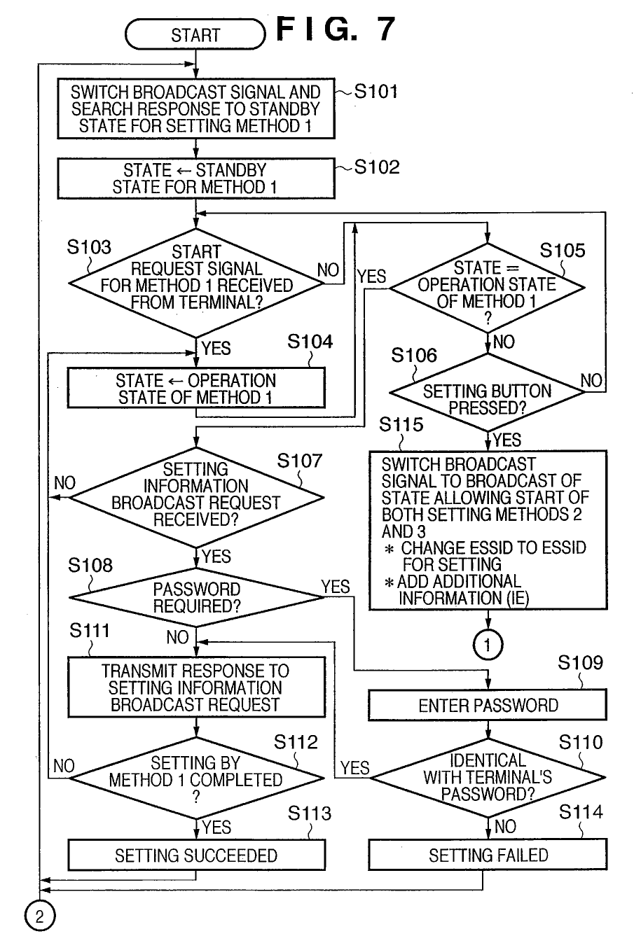

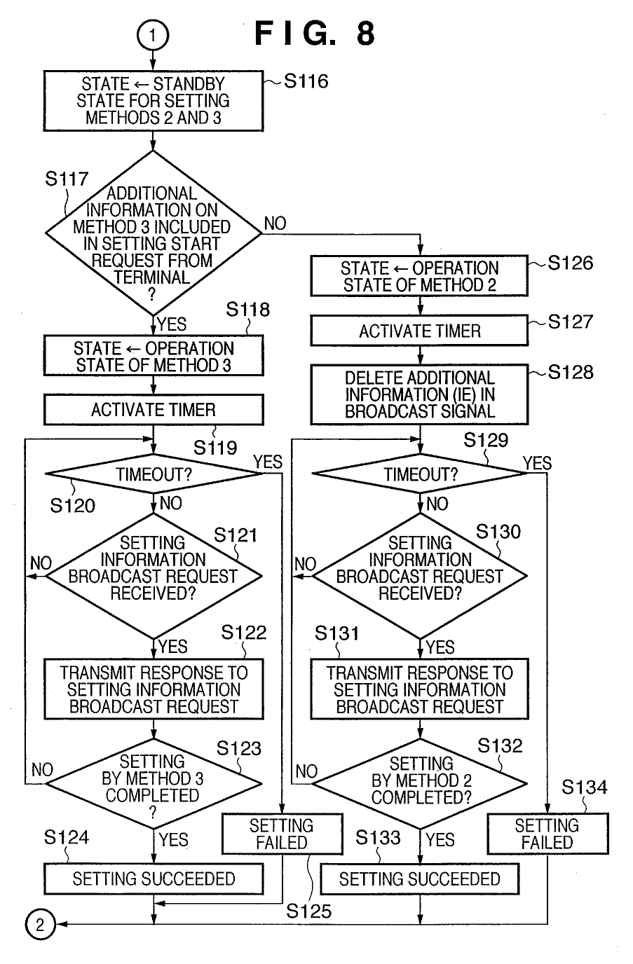

FIGS. 7 and 8 depict flowcharts describing wireless parameter setting processing of the base station apparatus 101 according to the first embodiment. A program that implements this processing is stored in the ROM 202 and executed under the control of the controller (CPU) 201.

First, in step S101 in FIG. 7, the switching processor 213 is instructed to switch the broadcast/search response signal to the format for the “standby state for setting method 1” 501. This causes the base station apparatus 101 to be set in the “standby state for setting method 1” in step S102. In step S103, it is determined whether a signal representing a start request for setting method 1 is received from a wireless terminal. If the signal is not received, the process proceeds to step S105. If the signal is received, the process proceeds to step S104 to change the state to the “operation state of setting method 1” 505 and proceeds to step S105. In step S105, it is determined whether the state is the “operation state of setting method 1” 505. If so, the process proceeds to step S107 to perform processing by setting method 1. That is, in step S107, it is determined whether a setting information broadcast request is received from the wireless terminal. If the request is not received, the process returns to step S104. If the request is received in step S107, the process proceeds to step S108 to determine whether a password is required or not. If a password is required, the process proceeds to step S109 to wait for a password to be entered. Once a password is entered, the process proceeds to step S110 to determine whether the password is identical with the wireless terminal's password. If they are not identical, the process proceeds to step S114 to determine that the setting is failed and returns to step S101. If the passwords are identical in step S110, the process proceeds to step S111 to send a response to the parameter setting information broadcast request. In step S112, it is determined whether the setting by parameter setting method 1 is completed. If not completed, the process returns to step S104 to perform the above-described processing. Once the setting by setting method 1 is completed, the process proceeds to step S113 to determine that the setting is successful and returns to the initial state in step S101.

If the state is not the “operation state of setting method 1” 505 in step S105, the process proceeds to step S106 to determine whether the setting button 104 is pressed. If the setting button 104 is not pressed, the process returns to step S103. If the setting button 104 is pressed, the process proceeds to step S115 to switch the broadcast signal and the search response signal to the “standby state for setting methods 2 and 3” 502. That is, the ESSID is changed to the “ESSID for setting method 2”, and the additional information on setting method 3 is added. The process proceeds to step S116 to change the state to the “standby state for setting methods 2 and 3” 502 and proceeds to step S117 (FIG. 8).

In step S117 in FIG. 8, it is determined whether a setting start request from the wireless terminal includes additional information on setting method 3. If so, the process proceeds to step S118 to set the state to the “operation state of setting method 3” 504. In step S119, time measurement by a timer is started. In step S120, it is determined whether a timeout occurs according to the timer. If a timeout occurs, the process proceeds to step S125 to decide that the setting is failed and returns to the initial state in step S101.

If a timeout does not occur in step S120, the process proceeds to step S121 to determine whether a setting information broadcast request is received from the wireless terminal. If it is determined that a request is received, the process proceeds to step S122, where a response message for the request is transmitted to notify of the currently set setting method (setting method 3). In step S123, completion of setting by setting method 3 is waited for. Once the setting is completed, the process proceeds to step S124 to determine that the setting is successful and returns to step S101. If the setting is not completed in step S123, the process returns to step S120 to perform the above-described processing.

If it is determined in step S117 that the setting start request from the wireless terminal does not include additional information on setting method 3, the process proceeds to step S126 to set the state to the “operation state of setting method 2” 503. The process proceeds to step S127 to start the time measurement by the timer. In step S128, the additional information on setting method 3 is deleted in the broadcast signal and the search response. The process proceeds to step S129 to check for the occurrence of a timeout. If a timeout does not occur, the process proceeds to step S130 to determine whether a setting information broadcast request is received. If the request is received, the process proceeds to step S131 to send a response message for the broadcast request. In step S132, it is determined whether the setting by setting method 2 is completed. If not completed, the process returns to step S129 to perform the above-described processing. If it is determined that the setting is completed, the process proceeds to step S133 to decide that the setting by setting method 2 is successful and returns to the initial state in step S101. If the timeout occurs in step S129, the process proceeds to step S134 to determine that the setting is failed and returns to the initial state in step S101.

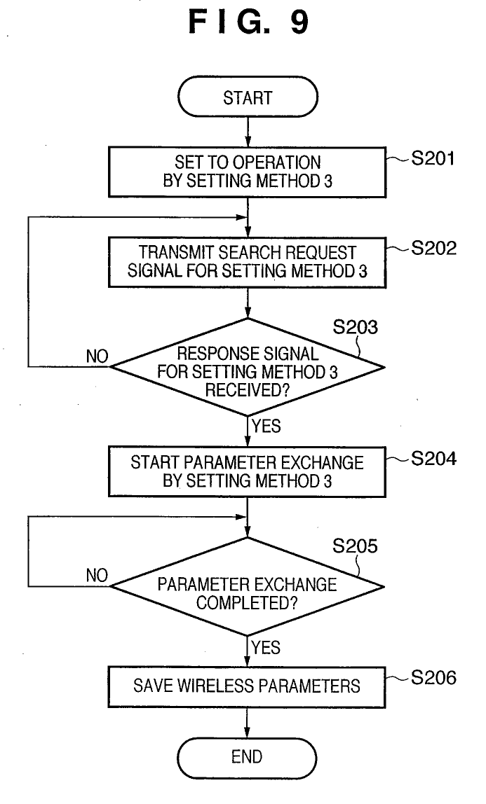

FIG. 9 is a flowchart describing processing of the wireless terminal 103 according to this embodiment for acquiring wireless parameters from the base station apparatus 101 by the third wireless parameter setting method. A program that implements this processing is stored in the ROM 402 and executed under the control of the CPU of the controller 401.

First, in step S201, wireless parameter setting method 3 is activated. The process proceeds to step S202 to send a search request signal for setting method 3 to the base station apparatus 101. The process proceeds to step S203 to determine whether a search response signal for setting method 3 is received from the base station apparatus 101. If it is determined that the search response signal is not received, the process returns to step S202. If it is determined that the search response signal is received, the process proceeds to step S204 to start a protocol for starting parameter exchange by the setting method 3 between the wireless terminal and the base station apparatus 101. The process proceeds to step S205 to determine whether the parameter exchange is completed. If completed, the process proceeds to step S206 to save the wireless parameters and terminates this processing.

The above description has been made for the case where the wireless terminal 103 transmits the search request. Alternatively, without transmitting the search request, the wireless terminal 103 may receive a broadcast signal from the base station apparatus 101 and, if it is found that the base station apparatus 101 supports the third wireless parameter setting method, start parameter exchange processing.

Thus, according to the first embodiment, the setting button 104 of the base station apparatus 101 supporting the first, second, and third wireless parameter setting methods is operated. This allows the first and second wireless terminals to set wireless parameters by the second or third wireless parameter setting method that they can implement.

### Second Embodiment

Now, a second embodiment of the exemplary present invention will be described. The second embodiment will be described about operation in the case where, while the base station apparatus 101 and a wireless terminal are wirelessly connected in a normal state, the setting button 104 of the base station apparatus 101 is pressed to cause setting of wireless parameters between the base station apparatus 101 and another wireless terminal. Since the configurations of the wireless communication system as well as the base station apparatus and the wireless terminals included in the system according to the second embodiment are the same as in the above-described first embodiment, they will not be described again.

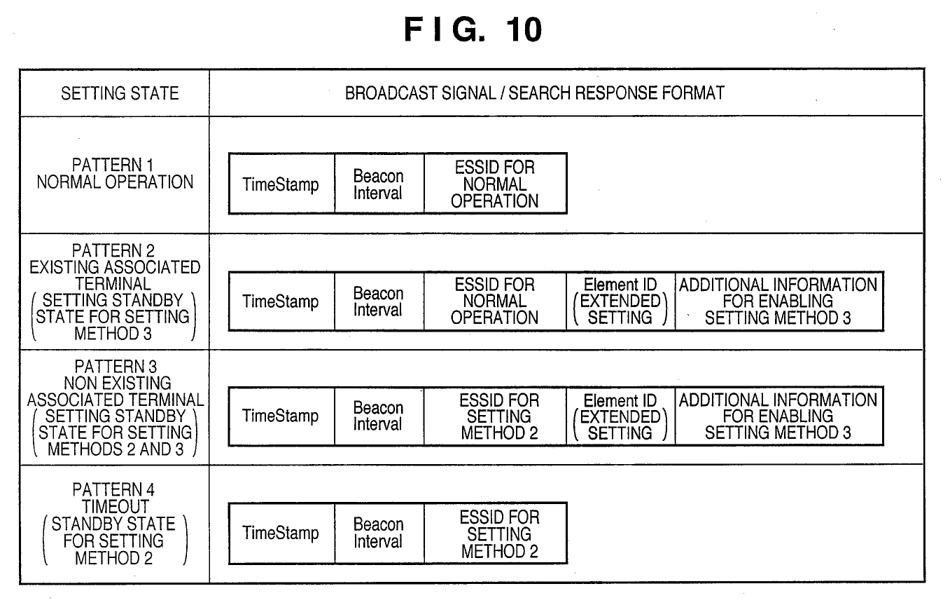

FIG. 10 is a diagram describing the formats of the broadcast signal and the response signal switched depending on the state of the setting methods by the switching processor 213 of the base station apparatus 101 according to the second embodiment.

“Pattern 1” (normal operation) indicates a broadcast signal/response signal format for the base station apparatus 101 in a normal operation state with no connected wireless terminals. This format includes TimeStamp indicating a timestamp, and BeaconInterval indicating the transmission time interval of the broadcast signal. Also, “ESSID for normal operation”, which is an identifier in normal operation, is set as the network identifier.

“Pattern 2” (existing associated terminal) indicates a signal format for the base station apparatus 101 in the state where the setting button 104 is pressed while a wirelessly connected (associated) wireless terminal exists. This format includes the TimeStamp indicating a timestamp, and the BeaconInterval indicating the transmission time interval of the broadcast signal. Also, the “ESSID for normal operation”, which is an identifier in normal operation, is set as the network identifier. Further included are ElementID (extended setting) indicating the presence of additional information representing the third wireless parameter setting method, and “additional information for enabling setting method 3”.

“Pattern 3” (non existing associated terminal) indicates a broadcast/search response signal format for the base station apparatus 101 in the state where the setting button 104 is pressed while no wirelessly connected wireless terminal exists. This format includes the TimeStamp indicating a timestamp, and the BeaconInterval indicating the transmission time interval of the broadcast signal. Also, “ESSID for setting method 2”, which is an identifier indicating that the second wireless parameter setting method is operating, is set as the network identifier. Further, the additional information representing the third wireless parameter setting method is included.

“Pattern 4” (timeout) indicates a signal format for the base station apparatus 101 in the state where the second wireless parameter setting method is operating. This format includes the TimeStamp indicating a timestamp, and the BeaconInterval indicating the transmission time interval of the broadcast signal. Also, the “ESSID for setting method 2”, which is an identifier indicating that the second wireless parameter setting method is operating, is set as the network identifier.

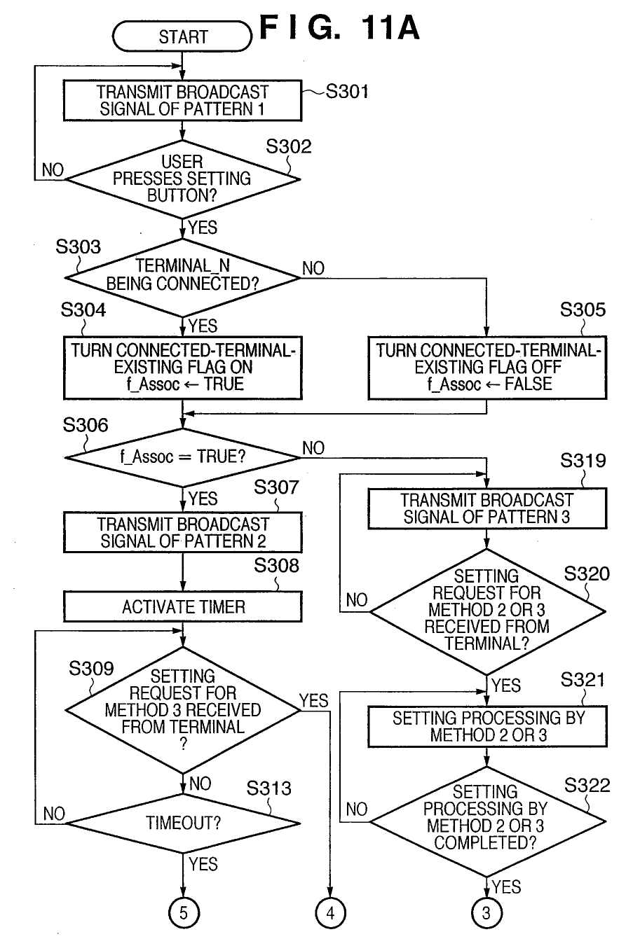

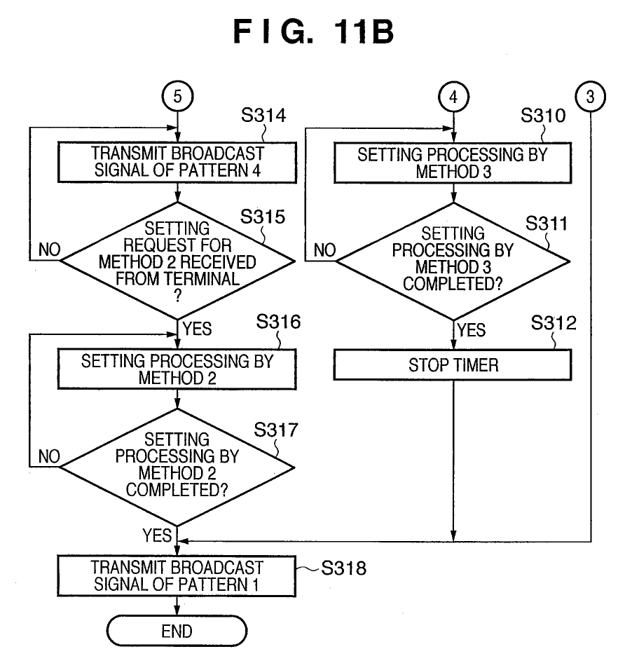

FIGS. 11A and 11B are flowcharts describing a wireless parameter setting process of the base station apparatus 101 according to the second embodiment of the present invention. A program that implements this processing is stored in the ROM 202 and executed under the control of the CPU of the controller 201.

First, in step S301, a signal is periodically transmitted with the pattern 1 as a regular broadcast signal. The process proceeds to step S302 to determine whether a user presses the setting button 104. If the button 104 is pressed, the process proceeds to step S303 to check whether a wirelessly connected wireless terminal exists. If a wirelessly connected wireless terminal exists in step S303, the process proceeds to step S304 to turn a connected-terminal-existing flag on (set an f_Assoc flag to TRUE) and proceeds to step S306. If no connected wireless terminals exist in step S303, the connected-terminal-existing flag is turned off (the f_Assoc flag is set to FALSE), and the process proceeds to step S306.

In step S306, it is determined whether the connected-terminal-existing flag is on. If so, the process proceeds to step S307, where the broadcast signal is switched to the pattern 2 (standby state for setting methods 2 and 3) and transmitted for allowing the third wireless parameter setting method (setting method 3). Next, in step S308, a timer is activated. The wireless terminal already connected at this point in time has its wireless connection maintained. The process proceeds to step S309 to determine whether a setting request for setting method 3 is received from the wireless terminal. If it is determined that the setting request is received, the process proceeds to step S310 to perform processing such as setting protocol processing by setting method 3. The process then proceeds to step S311 to determine whether the setting of wireless parameters by setting method 3 is completed. If completed, the process proceeds to step S312 to stop the timer and proceeds to step S318. In step S318, the broadcast signal is returned to the initial pattern 1 (normal operation) and the process terminates.

If the setting request is not received in step S309, the process proceeds to step S313 to determine whether a waiting time period for waiting for a setting request of a setting method 3 from the wireless terminal has passed and a timeout occurs. If the timeout occurs, the process proceeds to step S314 to switch the broadcast signal to the pattern 4 (setting standby sate for setting method 2) and transmit the broadcast signal to the wireless terminal. In step S315, a setting request for the second wireless parameter setting method (method 2) is waited for. If the setting request for setting method 2 is received, the process proceeds to step S316 to perform processing such as setting protocol processing by setting method 2. In step S317, it is determined whether the setting by setting method 2 is completed. If completed, the process proceeds to step S318 to return the broadcast signal to the initial pattern 1 and terminates.

If no wireless terminals are connected to the base station apparatus 101 (the connected-terminal-existing flag is off) in step S306, the process proceeds to step S319 to transmit the broadcast signal of the pattern 3 for allowing both the setting methods 2 and 3. The process proceeds to step S320 to determine whether a setting request for setting method 2 or 3 is received from a wireless terminal. If the setting request is received, the process proceeds to step S321 to perform setting processing according to a protocol of setting method 2 or 3 correspondingly. In step S322, it is determined whether the setting processing is completed. If completed, the process proceeds to step S318 to return the broadcast signal to the initial pattern 1 and terminates the process.

Thus, according to the second embodiment, for one setting method in a plurality of wireless parameter setting methods that the base station apparatus 101 has, the network identifier is changed to a specified value corresponding to that setting method to notify a wireless terminal of the setting mode. For another setting method, a broadcast signal containing additional information can be transmitted to notify the wireless terminal of the setting mode. In a case that any wireless terminal is already in wireless connection with the base station apparatus, changing the network identifier to a specified value would disconnect this wirelessly connected wireless terminal. Control as performed in the second embodiment can advantageously allow any connected wireless terminal to maintain communication without disconnection as far as possible while allowing a plurality of wireless parameter settings to be implemented.

### Third Embodiment

Now, a third embodiment of the present invention will be described. The third embodiment will be described about operation for setting wireless parameters in a case that the base station apparatus 101 is operating in a stealth mode in which the network identifier is hidden from any wireless terminals. Since the configurations of the wireless communication system as well as the base station apparatus and the wireless terminals included in the system according to the third embodiment are the same as in the above-described first embodiment, they will not be described again.

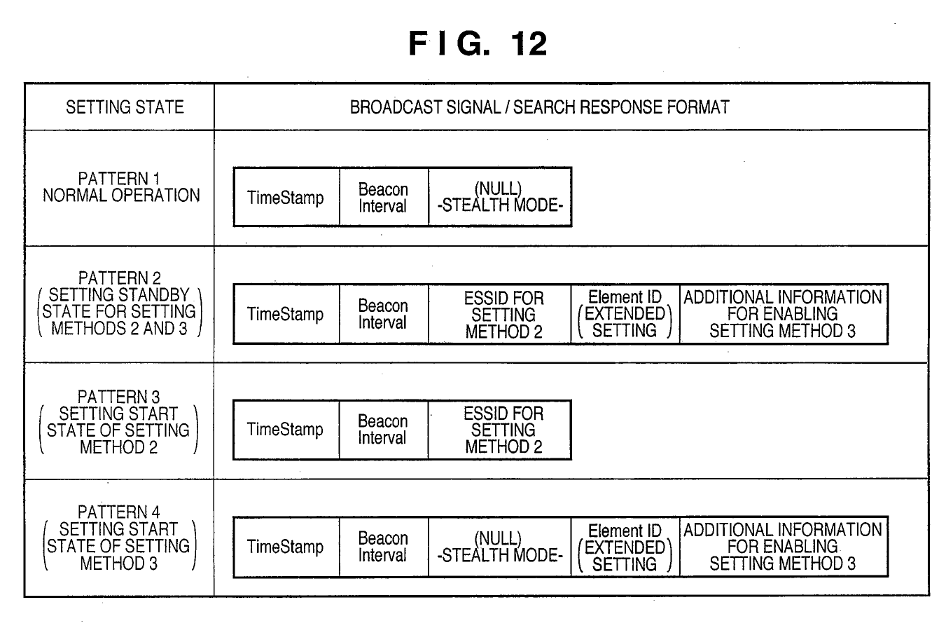

FIG. 12 is a diagram describing the formats of the broadcast signal and the search response signal switched depending on the state of the setting methods by the switching processor 213 of the base station apparatus 101 according to the third embodiment of the present invention.

“Pattern 1” (normal operation) indicates a signal format for the base station apparatus 101 set to a “normal operation state”. This format includes TimeStamp indicating a timestamp, and BeaconInterval indicating the transmission time interval of the broadcast signal. Since the apparatus is in the stealth mode, nothing is set as the network identifier.

“Pattern 2” indicates a signal format for the base station apparatus 101 set to the state where the second wireless parameter setting method (method 2) and the third wireless parameter setting method (method 3) are operating in parallel when the setting button 104 is pressed. This format includes the TimeStamp indicating a timestamp, and the BeaconInterval indicating the transmission time interval of the broadcast signal. Also, “ESSID for setting method 2” is set as the network identifier. Further included are ElementID (extended setting) indicating the presence of additional information representing setting method 3, and “additional information for enabling setting method 3”.

“Pattern 3” indicates a signal format for the base station apparatus 101 set to the state where setting by setting method 2 has been started. This format includes the TimeStamp indicating a timestamp, and the BeaconInterval indicating the transmission time interval of the broadcast signal. Also, the “ESSID for setting method 2”, which is an identifier indicating that the second wireless parameter setting method is operating, is set as the network identifier.

Further, “pattern 4” indicates a signal format for the base station apparatus 101 set to the state where setting by setting method 3 has been started. This format includes the TimeStamp indicating a timestamp, and the BeaconInterval indicating the transmission time interval of the broadcast signal. Since the apparatus is in the stealth mode, nothing is set as the network identifier (NULL). Further included are the ElementID (extended setting) indicating the presence of additional information representing setting method 3, and the “additional information for enabling setting method 3”.

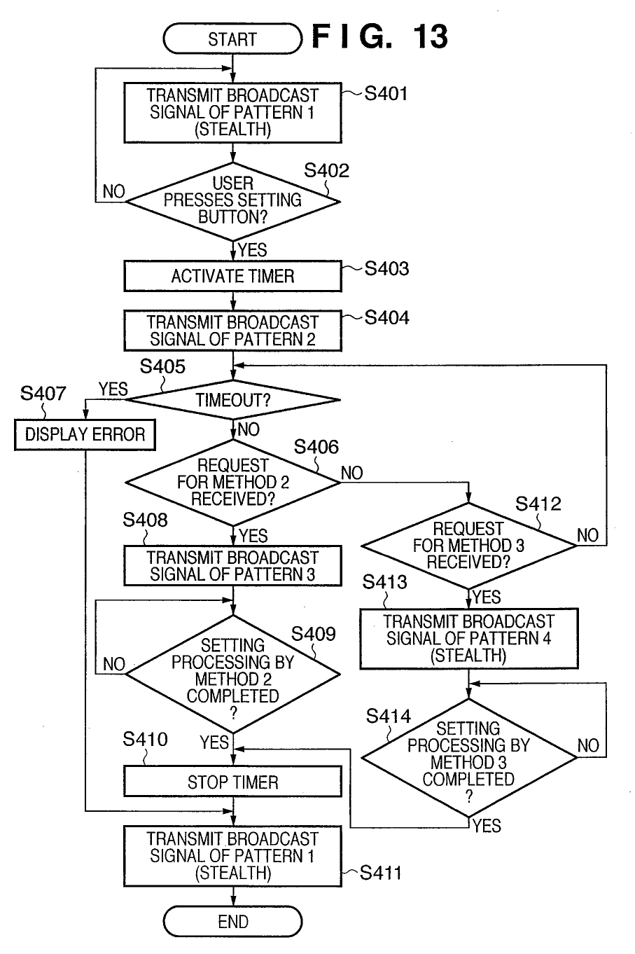

FIG. 13 is a flowchart describing a wireless parameter setting process of the base station apparatus 101 according to the third embodiment. A program that implements this processing is stored in the ROM 202 and executed under the control of the CPU of the controller 201.

First, in step S401, a signal is periodically transmitted with the pattern 1 in the stealth mode as a regular broadcast signal. In step S402, it is determined whether the setting button 104 is pressed. If the setting button 104 is pressed, the process proceeds to step S403 to activate a timer that measures a set time period. The process proceeds to step S404 to switch the broadcast signal to the pattern 2 (standby state for setting methods 2 and 3) and temporarily exits the stealth mode.

In step S405, it is determined whether a timeout occurs according to the timer activated in step S403. If the timeout occurs, the process proceeds to step S407 to display an error indication and then proceeds to step S411.

If the timeout does not occur, the process proceeds to step S406 to determine whether a setting request for setting method 2 is received from the wireless terminal. If the setting request is received, the process proceeds to step S408, where the broadcast signal is switched to the pattern 3 (setting standby state for setting method 2) allowing only setting method 2 and transmitted. In step S409, completion of setting protocol processing by setting method 2 is waited for. Upon completion, the process proceeds to step S410 to stop the time measurement by the timer. The process proceeds to step S411 to return the broadcast signal to the initial pattern 1 and terminates the process.

If the setting request for setting method 2 is not received from the wireless terminal in step S406, the process proceeds to step S412 to determine whether a setting request for setting method 3 is received from the wireless terminal. If the setting request is not received, the process returns to step S405. On the other hand, if the setting request is received, the process proceeds to step S413 to transmit the broadcast signal switched to the pattern 4 (setting started by setting method 3) with the network identifier set in the stealth mode and the additional information representing setting method 3 added. In step S414, completion of setting protocol processing by setting method 3 is waited for. Upon completion, the process proceeds to step S410 to stop the time measurement by the timer. The process proceeds to step S411 to return the broadcast signal to the initial pattern 1 and terminates the process.

Thus, according to the third embodiment, setting by a plurality of wireless parameter setting methods can be allowed even when the base station apparatus 101 is set to the stealth mode. In addition, if setting by setting method 2 is started with a wireless terminal, the additional information on setting method 3 is deleted from the broadcast signal to prevent a setting request for setting method 3 from other wireless terminals. Further, if setting by setting method 3 is started, the network identifier in the broadcast signal can be set to the stealth mode to prevent a setting request for setting method 2 from other wireless terminals. In this manner, this embodiment can advantageously inhibit setting by other setting methods in such cases where setting with terminal-by-terminal checking is desired from a security standpoint.

### Fourth Embodiment

Now, a fourth embodiment of the present invention will be described. In the fourth embodiment, the base station apparatus 101 is operating in the stealth mode in which the network identifier is hidden from any wireless terminals. The description will be given about operation in the case where, in a case that a wireless terminal is in normal connection with the base station apparatus 101, the setting button 104 is pressed to cause setting of wireless parameters between the base station apparatus 101 and another wireless terminal. Since the configurations of the wireless communication system as well as the base station apparatus and the wireless terminals included in the system according to the fourth embodiment are the same as in the above-described first embodiment, they will not be described again.

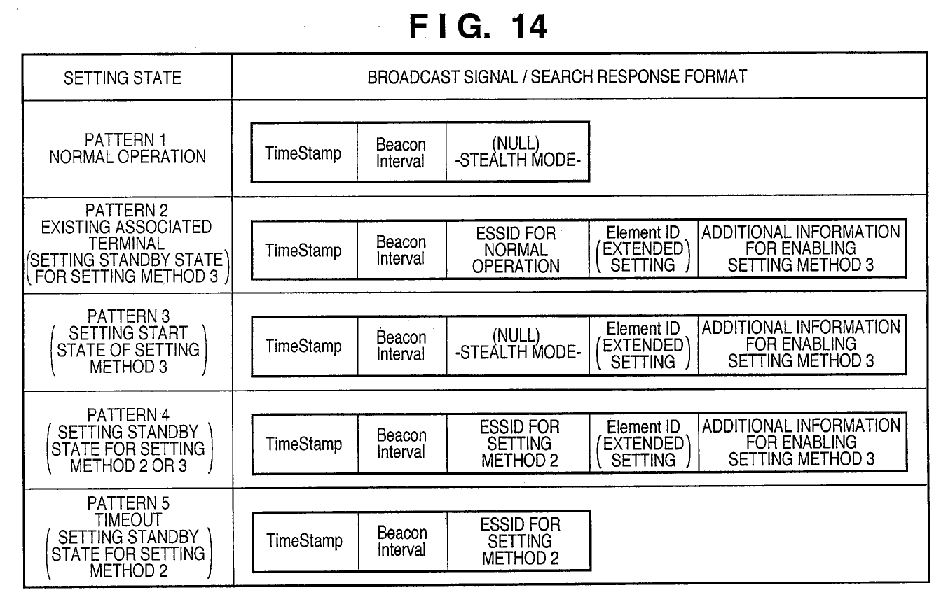

FIG. 14 is a diagram describing the formats of the broadcast signal and the search response signal switched depending on the state of the setting methods by the switching processor 213 of the base station apparatus 101 according to the fourth embodiment.

“Pattern 1” (normal operation) indicates a broadcast signal/search response signal format for the base station apparatus 101 set to a “normal operation state” with no wirelessly connected wireless terminal. This format includes TimeStamp indicating a timestamp, and BeaconInterval indicating the transmission time interval of the broadcast signal. Since the apparatus is in the stealth mode, nothing is set as the network identifier.

“Pattern 2” indicates a signal format for the base station apparatus 101 set to the state where the setting button 104 is pressed while a wirelessly connected wireless terminal exists. This format includes the TimeStamp indicating a timestamp, and the BeaconInterval indicating the transmission time interval of the broadcast signal. Also, “ESSID for normal operation”, which is an identifier in normal operation hidden in the stealth mode, is set as the network identifier. Further included are ElementID (extended setting) indicating the presence of additional information representing the third wireless parameter setting method (setting method 3), and “additional information for enabling setting method 3”.

“Pattern 3” indicates a signal format for the base station apparatus 101 set to the state where setting by setting method 3 has been started. This format includes the TimeStamp indicating a timestamp, and the BeaconInterval indicating the transmission time interval of the broadcast signal. As the network identifier, the “ESSID for normal operation”, which is an identifier in normal operation, is set to the stealth mode. Further, the “additional information for enabling setting method 3” representing the third wireless parameter setting method is included.

“Pattern 4” indicates a signal format for the base station apparatus 101 set to the standby state for the second wireless parameter setting method (setting method 2) and the third wireless parameter setting method (setting method 3). This format includes the TimeStamp indicating a timestamp, and the BeaconInterval indicating the transmission time interval of the broadcast signal. Also, “ESSID for setting method 2”, which is an identifier indicating that the second wireless parameter setting method is operating, is included as the network identifier. Further, the “additional information for enabling setting method 3” representing the third wireless parameter setting method is included.

“Pattern 5” indicates a signal format for the base station apparatus 101 set to the state where setting by setting method 2 has been started. This format includes the TimeStamp indicating a timestamp, and the BeaconInterval indicating the transmission time interval of the broadcast signal. Also, the “ESSID for setting method 2”, which is an identifier indicating that the second wireless parameter setting method is operating, is set as the network identifier.

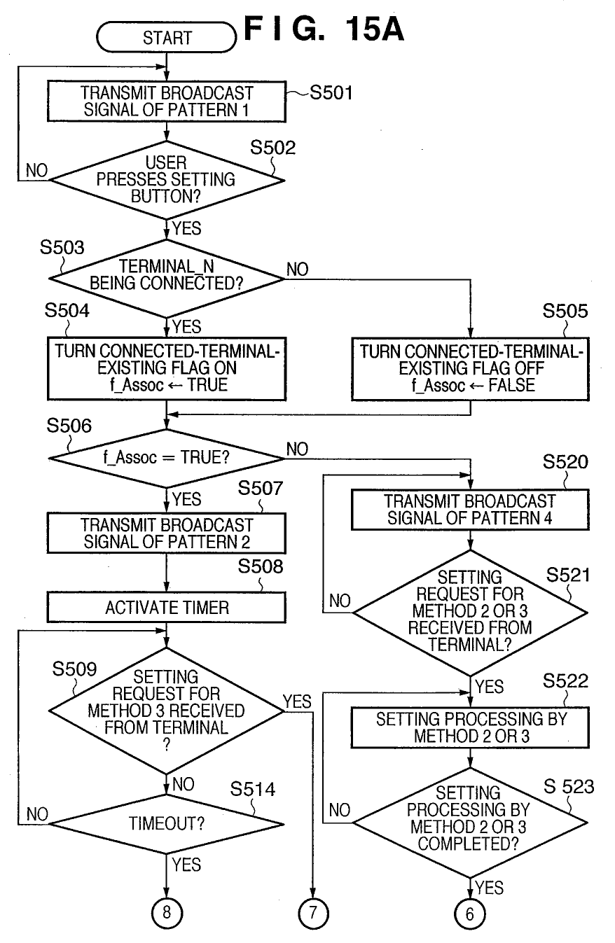

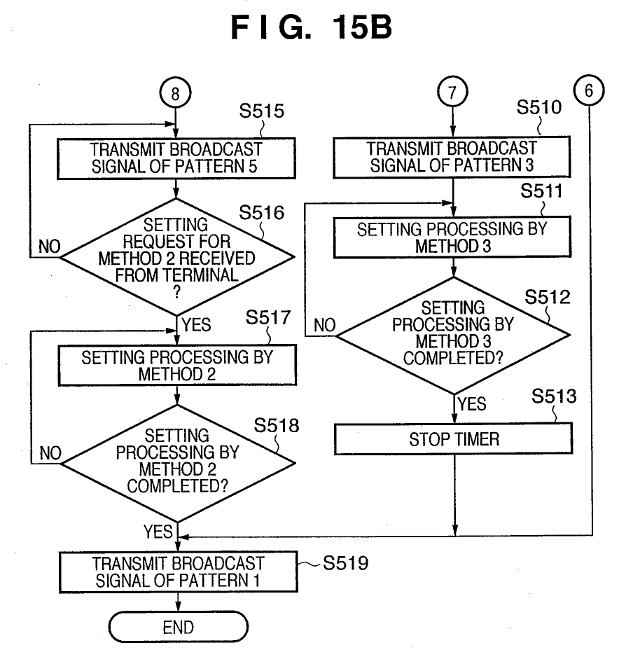

FIGS. 15A and 15B are flowcharts describing a wireless parameter setting process of the base station apparatus 101 according to the fourth embodiment. A program that implements this processing is stored in the ROM 202 and executed under the control of the CPU of the controller 201.

First, in step S501, a signal is periodically transmitted with the pattern 1 as a regular broadcast signal in the stealth mode in which the network identifier is hidden. Next, in step S502, pressing of the setting button 104 is waited for. Once the setting button 104 is pressed, the process proceeds to step S503 to determine whether a wirelessly connected wireless terminal exists. If a wirelessly connected wireless terminal exists, the process proceeds to step S504 to turn the connected-terminal-existing flag on (set the f_Assoc flag to TRUE). If no connected wireless terminals exist, the process proceeds to step S505 to turn the connected-terminal-existing flag off (set the f_Assoc flag to FALSE), and then proceeds to step S506.

In step S506, it is determined whether the connected-terminal-existing flag is on. If so, the process proceeds to step S507, where the broadcast signal is switched to the pattern 2 (standby state for setting method 3) in which the network identifier hidden in the stealth mode is set. The broadcast signal is then transmitted for allowing the third wireless parameter setting method (the setting method 3). In step S508, a timer is activated. The connection with the already wirelessly connected wireless terminal is maintained at this point in time.

In step S509, it is determined whether a setting request for setting method 3 is received from the wireless terminal. If the setting request is received, the process proceeds to step S510 to transmit the broadcast signal of the pattern 3 (setting started by setting method 3) with the network identifier hidden in the stealth mode. In step S511, processing such as setting protocol processing by setting method 3 is performed. In step S512, it is determined whether the setting by setting method 3 is completed. If completed, the process proceeds to step S513 to stop the time measurement by the timer. Then the process proceeds to step S519, the broadcast signal is returned to the initial pattern 1 and terminates.

If a waiting time period for waiting for a setting request of setting method 3 from the wireless terminal has passed and a timeout occurs in step S514, the process proceeds to step S515 to switch the broadcast signal to the pattern 5 (setting standby state for setting method 2) and transmit the broadcast signal. In step S516, a setting request for the second wireless parameter setting method (setting method 2) is waited for. If a setting-request for setting method 2 is received, the process proceeds to step S517 to perform processing such as setting protocol processing by setting method 2. In step S518; it is determined whether the setting by setting method 2 is completed. If completed, the process proceeds to step S519 to return the broadcast signal to the initial pattern 1 and terminates.

In step S506, if the connected-terminal-existing flag is off indicating that no wireless terminal is wirelessly connected to the base station apparatus 101, the process proceeds to step S520 to transmit the broadcast signal of the pattern 4 (standby state for setting methods 2 and 3) for allowing both the setting methods 2 and 3. The process then proceeds to step S521 to determine whether a setting request for setting method 2 or 3 is received from a wireless terminal. If the setting request is received, the process proceeds to step S522 to perform setting processing according to a protocol of setting method 2 or 3 correspondingly. The process proceeds to step S523 to determine whether the setting processing by setting method 2 or 3 is completed. If completed, the process proceeds to step S519 to return the broadcast signal to the pattern 1, which is the broadcast signal in the stealth mode with the network identifier hidden, and terminates the process.

Thus, according to the fourth embodiment, a wireless terminal can correctly discover the base station apparatus 101 and start registration operation even when the base station apparatus 101 is set to the stealth mode.

In addition, this embodiment can advantageously provide wireless parameter setting methods having both security and easy operability because the time period over which the stealth mode is exited can be set as short as possible.

### Other Embodiments

The present invention may be achieved in such a manner that a program of software for implementing the functions of the above-described embodiments is directly or remotely supplied to the system or apparatus, and a computer of the system or apparatus reads out and executes the supplied program. In this case, the software need not take the form of a program as long as it has program functions.

Therefore, a program code itself installed to the computer in order to implement functional processing of the present invention in the computer also realizes the present invention. That is, the claims of the present invention also include a computer program itself for implementing the functional processing of the present invention. In this case, the program may take any form including an object code, a program executed by an interpreter, or script data supplied to an OS, as long as it has program functions.

Various recording media may be used for supplying the program, for example, a floppy™ disk, hard disk, optical disk, magneto-optical disk, MO, CD-ROM, CD-R, CD-RW, magnetic tape, nonvolatile memory card, ROM, and DVD (DVD-ROM and DVD-R).

Alternatively, the program may be supplied by connecting to a website on the Internet via a browser on a client computer and downloading the program, which may be the computer program itself of the present invention or a compressed file of the computer program with an automatic installing function, from the website to a recording medium such as a hard disk. The present invention may also be realized by dividing the program code that constitutes the program of the present invention into a plurality of files and by downloading the files from different websites. That is, the claims of the present invention also include a WWW server that allows a plurality of users to download the program files for implementing the functional processing of the present invention in a computer.

The program of the present invention may be stored in an encrypted form in a storage medium such as a CD-ROM and distributed to users. A user who satisfies predetermined conditions is allowed to download decryption key information from a website over the Internet. The user uses the key information to install the encrypted program in an executable form to a computer.

The present invention may also be realized in a manner other than that the computer executes the read-out program to implement the functions of the above-described embodiments. For example, an OS or the like running on the computer may perform part or all of actual processing under instructions of the program to implement the functions of the above-described embodiments.

Further, the program read out from the recording medium may be written to memory provided in a function extension board inserted into the computer or in a function extension unit connected to the computer. In this case, a CPU or the like provided in the function extension board or function extension unit then performs part or all of actual processing under instructions of the program code to implement the functions of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2006-205315, filed Jul. 27, 2006, which is hereby incorporated by reference herein in its entirety.

What is claimed is:

1. A base station apparatus having a plurality of wireless parameter setting methods for setting wireless parameters between the base station apparatus and a wireless terminal, comprising:
a broadcast unit configured to notify of an operable method of the plurality of wireless parameter setting methods;
a switching unit configured to switch the operable method to be notified by said broadcast unit depending on an operation state of each of the plurality of wireless parameter setting methods;
a selection unit configured to select any of the plurality of wireless parameter setting methods based on a request for a wireless parameter setting method from a wireless terminal; and
a wireless parameter setting unit configured to perform setting processing according to the wireless parameter setting method selected by said selection unit.

2. The apparatus according to claim 1, wherein said broadcast unit notifies by using a broadcast signal regularly transmitted from the base station apparatus, or a response signal for a search request transmitted from the wireless terminal

3. The apparatus according to claim 1, further comprising:
a designation unit configured to designate an activation of wireless parameter setting processing,
wherein in response to designation by said designation unit, said switching unit switches the operable method to be notified of by said broadcast unit.

4. The apparatus according to claim 3, further comprising:
a determination unit configured to determine whether a first wireless terminal is wirelessly connected or not; and
a setting method selection unit configured to select a wireless parameter setting method requiring no change of a network identifier out of the plurality of wireless parameter setting methods, in a case that the designation by said designation unit is provided and said determination unit determines that the first wireless terminal is wirelessly connected.

5. The apparatus according to claim 4, further comprising:
a mode transition unit configured to transit to a mode in which a broadcast that a particular one of the plurality of wireless parameter setting methods is enabled is provided, in a case that said determination unit determines that the first wireless terminal is not wirelessly connected.

6. The apparatus according to claim 3, further comprising:
a first operation mode in which a network where a first network identifier is hidden and not announced is established;
a hiding cancellation unit configured to exit the first operation mode in response to the designation by said designation unit; and
a mode transition unit configured to transit to a second operation mode in which a broadcast of a activation state allowing concurrent operation of the plurality of wireless parameter setting methods is provided.

7. The apparatus according to claim 6, further comprising:
a unit configured to transit to a third operation mode in which the first network identifier is hidden again if a start request for an operable wireless parameter setting method is received from a second wireless terminal within a predetermined time period after transition to the second operation mode.

8. A control method for a base station apparatus having a plurality of wireless parameter setting methods for setting wireless parameters between the base station apparatus and a wireless terminal, comprising:
a broadcast step of notifying of an operable method of the plurality of wireless parameter setting methods;
a switching step of switching the operable method to be notified in said broadcast step depending on an operation state of each of the plurality of wireless parameter setting methods;
a selection step of selecting any of the plurality of wireless parameter setting methods based on a request for a wireless parameter setting method from a wireless terminal and the operation state of each of the plurality of wireless parameter setting methods; and
a wireless parameter setting step of performing setting processing according to the wireless parameter setting method selected in said selection step.

9. The method according to claim 8, wherein said broadcast step comprises notifying by using a broadcast signal regularly transmitted from the base station apparatus, or a response signal for a search request transmitted from the wireless terminal.

10. The control method according to claim 8, further comprising:
a designation step of designating to activate a wireless parameter setting processing,
wherein said switching step comprises, in response to the designation in said designation step, switching the operable method to be notified in said broadcast step.

11. The control method according to claim 10, further comprising:
a determination step of determining whether a first wireless terminal is wirelessly connected or not; and
a setting method selection step of selecting a wireless parameter setting method requiring no change of a network identifier out of the plurality of wireless parameter setting methods, in a case that the designation in said designation step is provided and it is determined that the first wireless terminal exists in said determination step.

12. The control method according to claim 11, further comprising:
a mode transition step of transitioning to a mode in which a broadcast that a particular method of the plurality of wireless parameter setting methods is enabled is provided, in a case that it is determined in said determination step that the first wireless terminal is not wirelessly connected.

13. The control method according to claim 10, further comprising:
a first operation mode in which a network where a first network identifier is hidden and not announced is established;
a hiding cancellation step of exiting the first operation mode in response to the designation in said designation step; and
a mode transition step of transitioning to a second operation mode in which a broadcast of an activation state allowing concurrent operation of the plurality of wireless parameter setting methods is provided.

14. The control method according to claim 13, further comprising:
a step of transitioning to a third operation mode in which the first network identifier is hidden again, in a case that a start request for an operable wireless parameter setting method is received from a second wireless terminal within a predetermined time period after transition to the second operation mode.
